(19) United States
(12) Patent Application Publication
(10) Pub. No.: US 2006/0027248 A1
(43) Pub. Date: Feb. 9, 2006

(54) Megasonic cleaning with minimized interference

(75) Inventors: John S. Lewis, Sunnyvale, CA (US); Brian J. Brown, Palo Alto, CA (US); Jun Zhao, Cupertino, CA (US); Steven Vehaverbeke, San Francisco, CA (US); Alexander Sou-Kang Ko, Santa Clara, CA (US); Rick R. Endo, San Carlos, CA (US); Roman Gouk, San Jose, CA (US); Pieter Boelen, Grenoble (FR)

Correspondence Address: DUGAN & DUGAN, PC, 55 SOUTH BROADWAY, TARRYTOWN, NY, 10591, US

(73) Assignee: APPLIED MATERIALS, INC.

(21) Appl. No.: 10/915,151

(22) Filed: Aug. 9, 2004

(51) Int. Cl. B08B 3/12; B08B 3/00

(52) U.S. Cl. 134/1; 134/34; 134/184

(57) ABSTRACT

In a first aspect, a first method of cleaning a substrate is provided that includes the steps of (1) forming a layer of cleaning solution on a major surface of a substrate; and (2) cleaning the major surface of the substrate by directing sonic energy substantially parallel to the major surface of the substrate through the layer of cleaning solution. Numerous other aspects are provided.

### FIELD OF THE INVENTION

The present invention relates generally to systems for fabricating semiconductor devices, and is more particularly related to methods and apparatus for cleaning substrates.

### BACKGROUND

Substrates may be cleaned by the use of acoustic waves. Conventional practices for acoustic cleaning include placing a substrate to be cleaned in a cleaning fluid, and using a megasonic transducer to create pressure waves within the cleaning fluid which act to remove contaminants, particulate matter, etc., from the surface of the substrate.

Interference created by intersecting pressure waves may create non-uniform cleaning. For example, constructive interference between intersecting waves (e.g., intersection of two waves simultaneously at their maxima) tends to increase cleaning power at the point of intersection. Destructive interference between intersecting waves (e.g., intersection of two waves simultaneously at their minima) tends to locally decrease cleaning power at the point of intersection. Such interference may form standing waves which do not contribute to substrate cleaning. Methods and apparatus for reducing the occurrence of and/or substantially preventing wave interference in cleaning systems are therefore desirable.

### SUMMARY

In a first aspect of the invention, a first method of cleaning a substrate is provided that includes the steps of (1) forming a layer of cleaning solution on a major surface of a substrate; and (2) cleaning the major surface of the substrate by directing sonic energy substantially parallel to the major surface of the substrate through the layer of cleaning solution.

In a second aspect of the invention, a second method is provided for cleaning a horizontally oriented substrate using acoustic waves. The second method includes the steps of (1) flowing a layer of cleaning fluid across a major surface of the substrate; (2) providing a sonic transducer adjacent the major surface of the substrate, the sonic transducer having a wave generating surface oriented substantially perpendicular to the major surface of the substrate; (3) establishing fluid communication between the major surface of the substrate and the wave generating surface of the sonic transducer through the flowing layer of cleaning fluid; and (4) energizing the sonic transducer so as to pass energy waves through the flowing layer of cleaning fluid and across at least a portion of the major surface of the substrate.

In a third aspect of the invention, a first apparatus is provided that is adapted to clean a major surface of a substrate. The first apparatus includes (1) a substrate holder adapted to support the substrate; (2) a cleaning solution supply adapted to receive cleaning solution from a source of cleaning solution and to form a layer of cleaning solution on the major surface of the substrate supported by the substrate holder; and (3) a transducer adapted to generate sonic energy, the transducer positioned so as to clean the major surface of the substrate supported by the substrate holder by directing sonic energy substantially parallel to the major surface of the substrate through the layer of cleaning solution.

In a fourth aspect of the invention, a second apparatus is provided for sonic cleaning of a substrate. The second apparatus includes (1) a substrate holder adapted to support and spin a substrate; (2) a sonic transducer adjacent the substrate holder, the sonic transducer comprising a wave generating surface oriented substantially perpendicular to a major surface of the substrate supported by the substrate holder; and (3) a fluid delivery mechanism adapted to form a flowing layer of fluid on the major surface of the substrate supported by the substrate holder and to establish fluid communication between the wave generating surface of the sonic transducer and the major surface of the substrate through the flowing layer of fluid. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 is a schematic side view of a substrate cleaning apparatus provided in accordance with a first embodiment of the current invention.

FIG. 2 is a schematic top view of the substrate cleaning apparatus of FIG. 1.

FIG. 3 is a schematic side view of a substrate cleaning apparatus configured in accordance with a second embodiment of the invention.

FIG. 4 is a schematic top view of the substrate cleaning apparatus of FIG. 3.

### DETAILED DESCRIPTION

In accordance with the present invention, megasonic cleaning of a substrate is performed by applying a layer of cleaning fluid to a major surface of the substrate, providing a megasonic transducer oriented substantially perpendicularly to the substrate surface, establishing fluid communication between the major surface of the substrate and the megasonic transducer through the layer of cleaning fluid, and activating the megasonic transducer so as to pass waves of sonic energy through the layer of cleaning fluid and over the substrate surface. By orienting the megasonic transducer perpendicularly relative to the substrate surface, the occurrence of wave interference caused by wave reflection may be substantially reduced and/or eliminated (as described further below).

In one or more embodiments of the invention, reflective surfaces may be provided that receive pressure waves from the transducer and direct the pressure waves so as to reduce an occurrence of wave interference. For example, such reflective surfaces may comprise one or more wave guides positioned adjacent the megasonic transducer. Other reflective surfaces may be positioned outside the substrate's circumference and adapted to reflect the energy waves out of the plane of the substrate so as to reduce an occurrence of interference with subsequent energy waves progressing across the surface of the substrate. An absorber may also be provided to absorb misdirected energy from the megasonic transducer, as further described below.

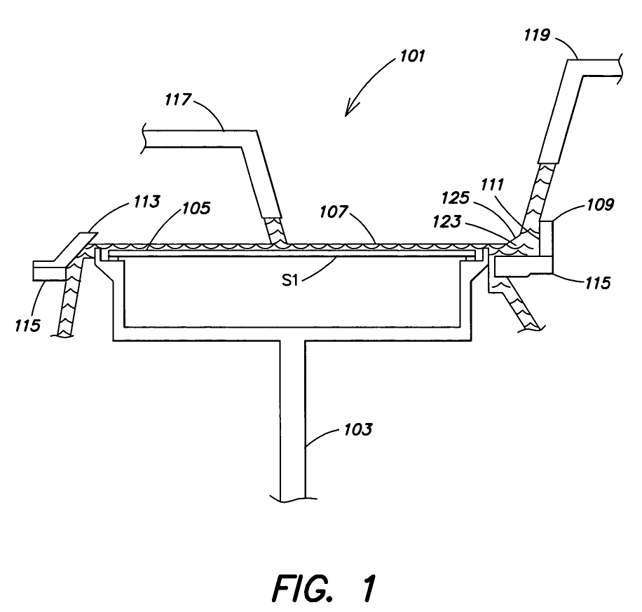

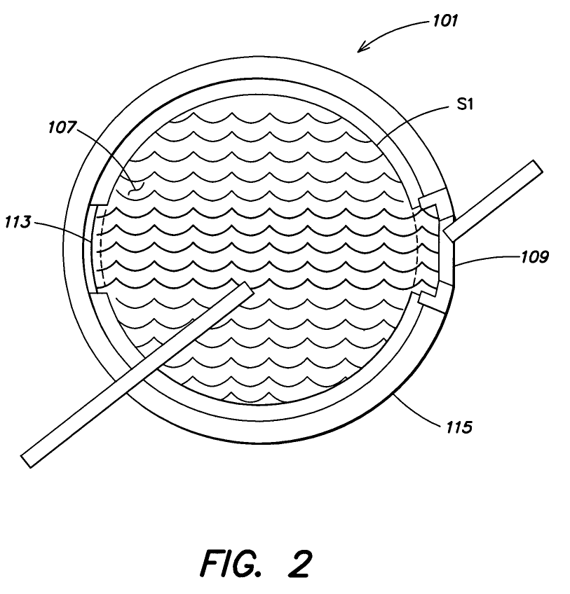

FIG. 1 is a schematic side view of a substrate cleaning apparatus 101 provided in accordance with a first embodiment of the current invention, and FIG. 2 is a schematic top view of the substrate cleaning apparatus of FIG. 1. Referring to FIG. 1, the substrate cleaning apparatus 101 may include a substrate holder 103 adapted to receive and support a substrate S1. For example, as shown in FIG. 1, the substrate holder 103 may be adapted to contact the substrate S1 from below and hold the substrate S1 in a horizontal orientation during one or more cleaning processes by which at least a surface 105 of the substrate S1 is cleaned. In addition, the substrate holder 103 may be adapted to spin the substrate S1.

The substrate cleaning apparatus 101 is adapted to megasonically clean the surface 105 of the substrate S1 by forming a layer 107 of cleaning fluid on the surface 105 and by passing waves of megasonic energy through the fluid layer 107 and over the surface 105 of the substrate S1. The megasonic energy is provided by a transducer 109. The formation of wave interference is discouraged and/or minimized via the orientation of the transducer 109 relative to the surface 105 of the substrate S1, and may be further reduced via the use of reflectors as described further below. In the embodiment of FIG. 1, the megasonic transducer 109 is oriented substantially perpendicularly to the surface 105 of the substrate S1. Cleaning fluid may be dispensed and/or permitted to flow such that the perpendicularly oriented megasonic transducer 109 remains in fluid communication with the surface 105 of the substrate S1. The present inventors observe that the perpendicular orientation of the megasonic transducer 109 relative to the surface 105 of the substrate S1 may minimize production of interfering sonic energy waves within the layer 107 of cleaning fluid.

With reference to FIG. 1, the megasonic transducer 109 is positioned such that the plane described by the surface 105 of the substrate S1 intersects a wave generating surface 111 of the megasonic transducer 109 (e.g., such that some portion of the wave generating surface 111 is disposed above, and some portion of the wave generating surface 111 is disposed below, the substrate's surface 105). Other positions for the megasonic transducer 109 relative to the substrate S1 are possible, including positions in which the plane described by the surface 105 of the substrate S1 passes entirely beneath the wave generating surface 111 of the megasonic transducer 109.

The substrate cleaning apparatus 101 may include one or more reflectors 113 adapted to receive waves of sonic energy generated by the megasonic transducer 109 and passed across the substrate S1, and to reflect the waves of sonic energy away from the surface 105 of the substrate S1. As is illustrated in the top plan view of FIG. 2, the substrate cleaning apparatus 101 includes one reflector 113. Other numbers may be employed. The megasonic transducer 109 is disposed outside the periphery of the substrate S1 and is oriented so that the major energy emitting surface of the transducer 109 directs energy toward the substrate S1. The reflector 113 may also be disposed outside the periphery of the substrate S1, and may be oriented so as to face the megasonic transducer 109 from across the substrate S1 and to achieve fluid communication with the layer 107 of cleaning fluid. From this position and/or orientation, the reflector 113 may receive energy waves that have progressed across the surface 105 of the substrate S1 through the layer 107 of cleaning fluid, and may reflect and/or redirect the energy waves away from the substrate S1 and preferably out of the plane described by the surface 105 of the substrate S1.

In a preferred aspect, the layer of cleaning fluid 107 is formed by continuously flowing cleaning fluid to a central region of the substrate S1 (e.g., via a centrally disposed fluid dispenser 117 as shown in FIG. 1). In such an aspect, and as shown in FIG. 1, the reflector 113 may act to guide a portion of the flow of cleaning fluid while reflecting the sonic energy downward and away from the horizontally oriented surface 105 of the substrate S1. Depending on the size and/or position of the reflector 113, the reflector 113 may redirect most and/or substantially all of the energy of the megasonic waves that progress across the substrate S1 from the megasonic transducer 109.

Either or both of the megasonic transducer 109 and the reflector 113 may be mounted on a support 115 positioned adjacent the substrate holder 103. For example, the support 115 may be an annular support positioned so as to surround the substrate holder 103 and permit the megasonic transducer 109 and the reflector 113 to be disposed beyond, but still adjacent to, the periphery of the substrate S1 so as to encourage fluid communication among the megasonic transducer 109, the reflector 113 and the layer 107 of cleaning fluid formed on the surface 105 of the substrate S1.

The substrate holder 103 may be adapted to keep the substrate S1 motionless during megasonic cleaning. Alternatively, the substrate holder 103 may be adapted to spin the substrate S1. The substrate S1 may be spun at any time before, during, and/or after megasonic cleaning of the substrate S1.

In one embodiment, cleaning fluid such as SC1 (e.g., hydrogen peroxide and ammonium hydroxide) or any other suitable cleaning solution may be dispensed from the first dispenser 117 at a rate of about 200 milliliters/minute to about 1 liter/minute. Such an arrangement, when combined with substrate rotation of about 0-30 RPM, may provide a flowing layer 107 of cleaning fluid approximately 0.5-3 mm in thickness, which may be sufficiently thick to permit effective megasonic cleaning via a progression of megasonic waves across the surface 105 from the megasonic transducer 109 to the reflector 113. Such a layer of cleaning fluid is sufficiently thin to minimize and/or reduce the occurrence of (and/or the degree of) wave interference arising from wave reflection off of the surface of the flowing layer 107 or off of the surface 105 of the substrate S1. Other cleaning fluids, cleaning fluid flow rates, rotation rates, and/or layer thicknesses may be employed.

The substrate cleaning apparatus 101 may further include a second dispenser 119 (positioned near the megasonic transducer 109 in the embodiment of FIG. 1) adapted to dispense a supply of fluid onto a surface of the support 115. Fluid dispensed from the second dispenser 119 may supplement and/or merge with a flow of fluid from the first dispenser 117. In one embodiment, fluid may be dispensed from the second dispenser 119 at a rate of about 200 milliliters/minute to about 1 liter/minute. Such an arrangement, when combined with a substrate rotation rate of about 0-30 RPM, may serve to maintain the fluid communication between the megasonic transducer 109 and the surface 105 of the substrate S1 needed for megasonic wave propagation. Other flow rates and/or rotation rates may be employed.

As shown in FIG. 1, cleaning fluid dispensed from the second dispenser 119 may be directed in such a way as to permit fluid communication between the entire wave generating surface 111 of the megasonic transducer 109 and the surface 105 of the substrate S1, despite the substantially perpendicular orientation of the wave generating surface 111 relative to the surface 105 of the substrate S1. For example, a volume 123 of fluid which spans the gap between the megasonic transducer 109 and the surface 105 of the substrate S1 may describe an inclined and/or otherwise downward sloping fluid surface 125. The fluid surface 125 may be employed to guide megasonic waves toward the surface 105 of the substrate S1 from the wave generating surface 111 of the megasonic transducer 109, as well as toward the layer 107 of cleaning fluid, and may reduce the potential for wave interference (as the megasonic waves are directed away from the megasonic transducer 109). As shown in FIG. 1, cleaning fluid which passes between the substrate holder 103 and the support 115 may be permitted to continue to flow away from the substrate S1.

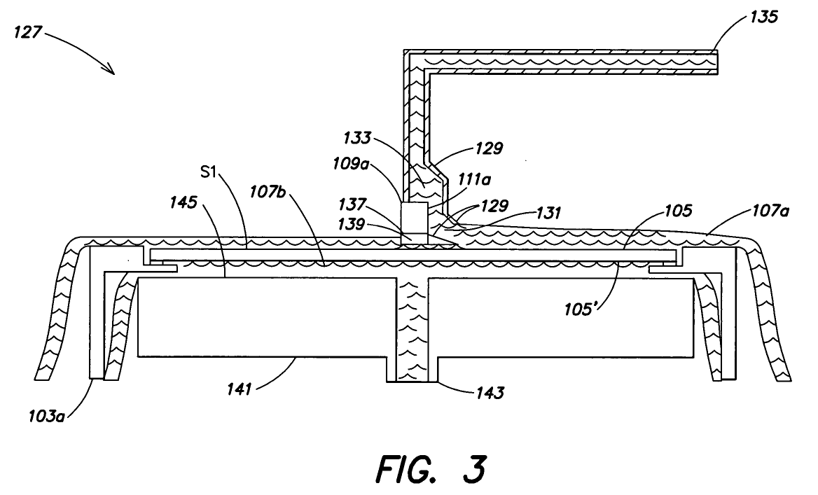

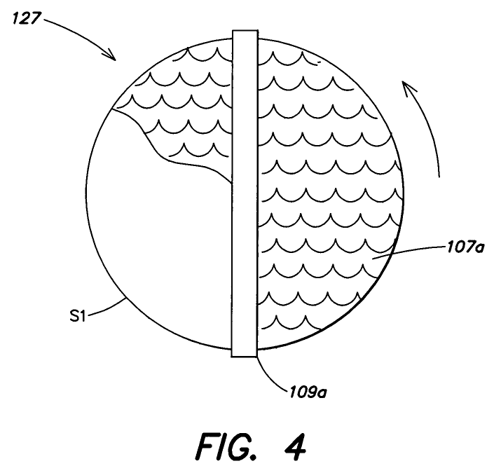

FIG. 3 is a schematic side view of a substrate cleaning apparatus 127 configured in accordance with a second embodiment of the invention. FIG. 4 is a schematic top view of the substrate cleaning apparatus 127 shown in FIG. 3. The substrate cleaning apparatus 127 may be similar to the substrate cleaning apparatus 101 shown in FIG. 1 and described above. For example, the substrate cleaning apparatus 127 may provide for a horizontal orientation of the substrate S1. Cleaning solution may be dispensed from within a perimeter of the substrate S1 and flowed onto the surface 105. Additionally, a megasonic transducer 109a may be employed having a wave generating surface 111a oriented substantially perpendicularly relative to the surface 105 of the substrate S1 that is to be megasonically cleaned.

As shown in FIG. 3, the megasonic transducer 109a of the substrate cleaning apparatus 127 is disposed within the perimeter of the substrate S1, unlike the apparatus of FIG. 1. For example, the megasonic transducer 109a may be disposed above the substrate S1 such that the surface 105 of the substrate S1 which the megasonic transducer 109a is adapted to clean extends beneath the wave generating surface 111a of the transducer 109a. The substrate cleaning apparatus 127 may further include one or more wave guides 129 positioned adjacent the megasonic transducer 109a. The wave guides 129 are adapted to guide megasonic waves originating from the wave generating surface 111a of the transducer 109a (as described below). The wave guides 129 also form a channel 131 that defines a volume 133 of cleaning fluid which is in fluid communication with the wave generating surface 111a of the megasonic transducer 109a. In the embodiment shown, the channel 131 is configured to guide megasonic waves through the volume 133 of cleaning fluid into a layer 107a of cleaning fluid formed on the surface 105 of the substrate S1. The channel 131 also may be adapted to reflect and/or redirect megasonic waves produced by the transducer 109a so that the megasonic waves travel laterally through the layer 107a, and across the surface 105 of the substrate S1, for purposes of megasonic cleaning. The wave guides may be formed from plastic (e.g., polyethylene, PTFE, etc.) or another suitable material. In at least one embodiment, the wave guides 129 are angled at about 0-60° from horizontal, although other angles may be used. As shown in FIG. 3, cleaning fluid may be supplied to the channel 131 via an input line 135 so as to maintain the volume 133 of cleaning fluid against the wave generating surface 111a, and to maintain a flowing layer 107a of cleaning fluid on the surface 105 of the substrate S1.

The substrate cleaning apparatus 127 may further comprise one or more absorbers 139 disposed between the megasonic transducer 109a and the layer 107a of cleaning fluid formed on the surface 105 of the substrate S1. Such absorbers may be positioned and/or configured so as to reduce and/or eliminate a potential source of wave interference. For example, an absorber may absorb energy that emanates from an end of the megasonic transducer 109a (e.g., from an end 137 positioned near the layer 107a of cleaning fluid formed on the surface 105 of the substrate S1). Absent the absorber, energy emanating from the end 137 of the transducer 109a may travel toward the surface 105 of the substrate S1 and reflect back toward the transducer 109, causing wave interference. The absorbers 139 may comprise plastic (e.g., polyethylene, PTFE, etc.), for example, or another suitable absorbing material.

As shown in FIG. 4, the megasonic transducer 109a of the substrate cleaning apparatus 127, may extend so as to approach, match, and/or exceed the diameter of the substrate S1. The waveguides 129, and/or of the channel 131, may be similarly extended so as to create a broad path of sonic wave transmission from the megasonic transducer 109a to the layer 107a of cleaning fluid formed on the surface 105 of the substrate S1 that extends across the entire diameter of the substrate S1. The absorber 139 may be similarly extended so as to absorb energy along the entire length of the megasonic transducer 109a.

In operation, the substrate holder 103a of the substrate cleaning apparatus is rotated (see FIG. 4), causing the substrate S1 to rotate beneath the megasonic transducer 109a. Cleaning solution is flowed into the channel 131, causing the volume 133 of cleaning fluid to form against the wave generating surface 111a of the megasonic transducer 109a, and a flowing layer 107a of cleaning fluid to form over at least a portion of the surface 105 of the substrate S1. Cleaning fluid flow rates, rotation rates and/or cleaning fluid layer thicknesses similar to those described above may be employed. A higher flow rate may be employed to compensate for the presence of only one fluid supply line (e.g., input line 135). For example, a flow rate of about 2 liters/minute may be employed in one embodiment (although larger or smaller flow rates also may be used).

The megasonic transducer 109a is energized, and waves of megasonic energy pass out of the channel 131, and across the surface 105 of the substrate S1 through the layer 107a, for purposes of megasonic cleaning thereof. Cleaning fluid that reaches an edge of the substrate S1 may be permitted to flow downward and away from the surface 105 of the substrate S1. (The substrate cleaning apparatus 127 preferably is configured to be relatively free of surfaces that cause megasonic energy to reflect back onto the surface 105 of the substrate S3 and/or wave interference).

As shown in FIG. 3, the substrate cleaning apparatus 127 may further be adapted to clean the second side 105′ of the substrate S1. For example, a plate 141 having a separate input 143 for the introduction of cleaning fluid may be positioned below the substrate S1. Fluid may be supplied through the input 143 so as to form a fluid layer 107b on top 145 of the plate 141 of sufficient thickness to contact the second (e.g., bottom) surface 105′ of the substrate S1. The fluid layer 107b on top of the plate 141 may then be megasonically energized (e.g., by a vertically oriented transducer (not shown), as described above, or by another conventional means).

The foregoing description discloses only exemplary embodiments of the invention. Modifications of the above disclosed apparatus and methods which fall within the scope of the invention will be readily apparent to those of ordinary skill in the art. For instance, the layers 107, 107a, 107b of cleaning fluid may be stationery layers of cleaning fluid, and/or need not cover the entire surface 105, 105′ of the substrate S1 at any given time. More than one transducer 109, 109a may be employed to increase the amount of the surface 105, 105′ exposed to megasonic energy. Transducers that are not oriented perpendicularly to the surface 105, 105′ of the substrate S1, but that nonetheless emit sonic energy substantially parallel to the surface 105, 105′ of the substrate S1 also may be employed.

Accordingly, while the present invention has been disclosed in connection with exemplary embodiments thereof, it should be understood that other embodiments may fall within the spirit and scope of the invention, as defined by the following claims.

The invention claimed is:

1. A method of cleaning a substrate comprising:
forming a layer of cleaning solution on a major surface of a substrate; and
cleaning the major surface of the substrate by directing sonic energy substantially parallel to the major surface of the substrate through the layer of cleaning solution.

2. The method of claim 1 wherein forming a layer of cleaning fluid on a major surface of the substrate comprises flowing cleaning fluid over the major surface of the substrate.

3. The method of claim 1 wherein cleaning the major surface of the substrate by directing sonic energy substantially parallel to the major surface of the substrate comprises:
providing a transducer having a wave generating surface that is positioned substantially perpendicular to the major surface of the substrate and adapted to generate sonic energy that is directed substantially parallel to the major surface of the substrate;
energizing the transducer so as to generate sonic energy; and
coupling the sonic energy to the layer of cleaning fluid.

4. The method of claim 3 wherein providing a transducer comprises positioning the transducer outside a perimeter of the substrate.

5. The method of claim 3 wherein providing a transducer comprises positioning the transducer above the substrate and employing one or more waveguides to direct sonic energy generated by the transducer substantially parallel to the major surface of the substrate.

6. The method of claim 1 further comprising reflecting sonic energy that travels past a perimeter of the substrate in a direction away from the transducer.

7. The method of claim 1 further comprising absorbing at least a portion of sonic energy generated by the transducer that is not directed substantially parallel to the major surface of the substrate.

8. The method of claim 1 wherein:
forming a layer of cleaning solution on a major surface of a substrate comprises forming a layer of cleaning solution on a first major surface of the substrate; and
cleaning the major surface of the substrate by directing sonic energy substantially parallel to the major surface comprises cleaning the first major surface of the substrate by directing sonic energy substantially parallel to the first major surface of the substrate.

9. The method of claim 8 further comprising:
forming a layer of cleaning solution on a second major surface of the substrate; and
cleaning the second major surface of the substrate by directing sonic energy substantially parallel to the second major surface of the substrate.

10. The method of claim 1 further comprising rotating the substrate.

11. A method of cleaning a horizontally oriented substrate using acoustic waves comprising:
flowing a layer of cleaning fluid across a major surface of the substrate;
providing a sonic transducer adjacent the major surface of the substrate, the sonic transducer having a wave generating surface oriented substantially perpendicular to the major surface of the substrate;
establishing fluid communication between the major surface of the substrate and the wave generating surface of the sonic transducer through the flowing layer of cleaning fluid; and
energizing the sonic transducer so as to pass energy waves through the flowing layer of cleaning fluid and across at least a portion of the major surface of the substrate.

12. An apparatus adapted to clean a major surface of a substrate comprising:
a substrate holder adapted to support the substrate;
a cleaning solution supply adapted to receive cleaning solution from a source of cleaning solution and to form a layer of cleaning solution on the major surface of the substrate supported by the substrate holder; and
a transducer adapted to generate sonic energy, the transducer positioned so as to clean the major surface of the substrate supported by the substrate holder by directing sonic energy substantially parallel to the major surface of the substrate through the layer of cleaning solution.

13. The apparatus of claim 12 wherein the substrate holder is adapted to rotate.

14. The apparatus of claim 12 wherein the cleaning solution supply is adapted to form a layer of cleaning fluid on a major surface of a substrate supported by the substrate holder by flowing cleaning fluid over the major surface of the substrate.

15. The apparatus of claim 12 wherein the transducer includes a wave generating surface positioned substantially perpendicular to the major surface of the substrate supported by the substrate holder and adapted to generate sonic energy that is directed substantially parallel to the major surface of the substrate.

16. The apparatus of claim 15 wherein the transducer is positioned outside a perimeter of the substrate.

17. The apparatus of claim 15 wherein the transducer is positioned above the substrate, and further comprising one or more waveguides adapted to direct sonic energy generated by the transducer substantially parallel to the major surface of the substrate.

18. The apparatus of claim 12 further comprising one or more reflectors adapted to reflect sonic energy that travels past a perimeter of the substrate in a direction away from the transducer.

19. The apparatus of claim 12 further comprising absorbing material positioned so as to absorb at least a portion of sonic energy generated by the transducer that is not directed substantially parallel to the major surface of the substrate.

20. Apparatus for sonic cleaning of a substrate, comprising:
a substrate holder adapted to support and spin a substrate;
a sonic transducer adjacent the substrate holder, the sonic transducer comprising a wave generating surface oriented substantially perpendicular to a major surface of the substrate supported by the substrate holder; and
a fluid delivery mechanism adapted to form a flowing layer of fluid on the major surface of the substrate supported by the substrate holder and to establish fluid communication between the wave generating surface of the sonic transducer and the major surface of the substrate through the flowing layer of fluid.
